(19) United States
(12) Patent Application Publication
(10) Pub. No.: US 2015/0088787 A1
(43) Pub. Date: Mar. 26, 2015

(54) METHOD, SOFTWARE AND GRAPHICAL USER INTERFACE FOR FORMING A PREDICTION MODEL FOR CHEMOMETRIC ANALYSIS

(71) Applicant: Carl Janson, Goteborg (SE)

(72) Inventor: Carl Janson, Goteborg (SE)

(73) Assignee: FOSS ANALYTICAL AB, Hoganas (SE)

(21) Appl. No.: 14/382,395

(22) PCT Filed: Mar. 6, 2012
(86) PCT No.: PCT/EP2012/053793

§ 371 Date: Sep. 2, 2014

(51) Int. Cl. G06N 99/00; G06F 3/0486; G06N 5/04; G06F 3/0481

(52) U.S. Cl. CPC G06N 99/005; G06F 3/0481; G06F 3/0486; G06N 5/04
USPC 706/11

(57) ABSTRACT

A method for forming a prediction model for chemometric analysis is presented. A first graphical area is configured to display a first set of graphical objects; each of the graphical objects is representing a calculation module suitable for use in the prediction model. A second graphical area is configured to display a second set of graphical objects representing the set of the calculation modules added to a prediction model. The calculation modules are added to the second area by the user. By building the calculation modules in such a way that any of the calculation modules may follow or be followed by any of the calculation modules, the user is allowed to add one/several calculation module(s) in any order and number, without restrictions.

### TECHNICAL FIELD

The present invention relates to a method and a graphical user interface for forming a prediction model for chemometric analysis.

### BACKGROUND ART

The general technical area of the invention concerns instruments and software for spectra analysis for chemometric purposes.

For the complex spectra analysis typically encountered in process systems, it is often desirable to use chemometric modelling to de-convolve the data gathered from the spectra in order to derive the properties of interest to the user.

Conventionally, the user builds the prediction model by selecting a number of the spectra for processing with the intent being to mathematically (e. g. statistically) correlate the monitored spectra with selected properties. Using the remaining spectra, the user then validates the model by running it on the remaining unused spectra, thereby generating predictions of the property or properties of the associated samples. A comparison of the predicted and analytically determined properties reveals the model's quality (e.g. how “good” the model is at making accurate predictions). If the comparison reveals that the model is not sufficiently accurate, the model must be modified or rebuilt from scratch.

The spectra are used as input data to a prediction model typically implemented in software. The regression algorithms in the prediction model can be both linear and non-linear and are based on complex mathematical functions, such as artificial neural networks or principal component analysis.

Presently, the algorithms of the prediction model are hard coded into the software and if a user of the software would like to change anything in the algorithms, e.g. to add another parameter, an additional mathematical function or a new regression algorithm, this requires a fairly complex rewrite of the entire software.

In WO2004/038602 A1, by David J. Baker, an integrated, modular, automated computer software based system for drug discovery biomarker discovery and drug screening is disclosed. The system comprises an application that accepts user input for building the prediction model. The user can select one of a plurality of regression techniques for use in the prediction model. The user can also save and re-load saved prediction models. The user can, to some extent, use available regression techniques and data transforming or scaling methods, to form a prediction model.

It may be noted that in the disclosed system there is a limited choice of options for the user while building the prediction model. Some parameters can be selected and changed but the most of the parts of the prediction model is still locked for editing.

Thus, there is still a need for an even more flexible method and software for forming a prediction model.

### SUMMARY OF INVENTION

It would be advantageously to achieve a method that allowed a more flexible way of forming a prediction model for chemometric analysis. It would also be desirable to achieve software that would implement the above mentioned method in an intuitive and simple way.

The present invention is based upon the realization that a prediction model can be considered to consist of one or more calculation modules. Each calculation module represents a mathematical operation. Each module has only the limited scope of receiving input, performing operation(s) and sending an output. For most modules, the input will be sequentially fed from an earlier module but in some circumstances a number of modules may feed their inputs in parallel from a single earlier module. However, this has no relevance for the module, only for the overall model construction. By understanding this, a much more flexible architecture for forming a prediction model can be allowed.

To better address one or more of these and other concerns, in a first aspect of the invention a method for forming a prediction model for chemometric analysis is presented that comprises: providing a computer readable storage medium containing a plurality of calculation modules, each of the plurality of calculation modules being a calculation module suitable for use in the prediction model, each of the plurality of calculation modules being arranged to receive data, having a required input data format, as input, perform a calculation and deliver data, having an output data format, as output, providing a processing unit for handling, by a former, the forming of the prediction model, providing a processing unit for operating, by an operator, the calculation modules previously added to the prediction model, providing a training data set with at least one known property for use when verifying the prediction model, providing a user interface for operating the calculation modules previously added to the prediction model, generating the plurality of calculation modules to be individually selectable, providing a user interface for adding at least one of the plurality of selectable calculation modules to the prediction model,

the method further comprising the steps of:
a) receiving, from the user interface for adding modules, a request for adding at least one of the plurality of calculation modules to the prediction mode;
b) adding, as a result of the request for adding, by the former, at least one calculation module to the prediction model, each of the plurality of calculation modules having an output data format being compatible with the required input data format of each of the plurality of calculation modules thereby allowing the step of adding at least one calculation module to the prediction model to be performed any number of times and permitting the calculation modules to operate in any order,
c) receiving, from the user interface for operating the calculation modules, a request for operating the calculation modules previously added to the prediction model;
d) operating, by an operator, the training data set on the calculation modules previously added to the prediction model thereby receiving at least one predicted property from the training data set;
e) verifying a quality of the prediction model by comparing the at least one predicted property with the at least one known property.

By “calculation modules” should, in the context of present method, be understood a mathematical function, or a group of mathematical functions, suitable for forming a prediction model. Examples of conventionally used mathematical function when forming a prediction model are PLS (partial least squares) and SIMCA (soft independent modelling of class analogies). The present invention separates these larger mathematical functions into sub functions, each of the sub functions are considered to be a separate calculation module. An example of a complex mathematical function being separated into sub functions is the PLS-function. Accordingly, the PLS-function may, for example, be separated into three sub functions:
Spectra treatment (including wavelength selection, scatter correction, derivative)
Centring and scaling of individual variables
PLS-algorithm

Another example is the SIMCA-function. According to the present invention the SIMCA-function may be separated into a plurality of, for example four, sub functions:
Spectra treatment (including wavelength selection, scatter correction, derivative)
Centring and scaling of individual variables
PCA-algorithm (principal component analysis)
SIMCA-algorithm

This approach of separating larger complex mathematical functions into sub functions that are individually selectable and addable to the prediction model is one of the reasons to why the present inventions may be considered to allow a more flexible way of forming a prediction model.

By “operating the prediction model” should, in the context of present method, be understood to run the data to be analyzed through the flow of calculation modules that forms the prediction model.

As mentioned above, when determining the prediction model's quality (e.g. verifying the model) a training data set with already analyzed properties may be needed. An advantage of this is that it may be easy to judge the quality of the prediction model by just comparing the predicted properties of the data run through the flow of the calculation modules with the already known properties of the same data.

By “computer readable storage medium” should, in the context of present method, be understood one of a removable non-volatile random access memory, a hard disk drive, a floppy disk, a CD-ROM, a DVD-ROM, a USB memory, an SD memory card, or a similar computer readable medium known in the art.

By allowing each of the calculation modules to be individually selectable and addable to the prediction model, and by building the calculation modules in such a way that any of the calculation modules may follow or be followed by any of the calculation modules, the prediction model may be formed in a fully flexible way, with no restrictions on what type of calculation module that may follow a already added calculation module. An advantage of this is that a user of this method is not bound by what calculation modules (e.g. mathematical function) that usually forms such a prediction model and in what order these calculation modules usually are operating in the prediction model, the user can, on the contrary, form the prediction model in any way possible using the calculation modules at hand.

The step of verifying the quality of the prediction model could be done in any suitable way. It could, for example, be done by comparing graphs plotting the predicted property of the data and the known property of the data. It could be done by exporting the predicted and known properties as a data file and analyze it in external software. It could also be done by printing the data side by side and comparing it by hand. It could also be done by letting software, which implements the above method, running an analysis of the predicted and the known properties and giving a measure of how well the prediction model predicted the values that are known.

According to an embodiment of the present invention, the operator is operating at least two of the calculation modules previously added to the prediction model in parallel. An effect of this is that the time it takes to run the data through the flow of calculation modules that forms the prediction model may be shortened. Because the calculation modules are built in the way described above, there is no limit to how many calculation modules can be run in parallel.

According to a further embodiment of the present invention, the method comprises providing a user interface for configuring parameters of each of the calculation modules, providing a processing unit for configuring, by a configurer, parameters of a calculation module, the method further comprising the steps of:
a) receiving, from the user interface for configuring parameters, a request for configuring a parameter of a calculation module,
b) configuring, as a result of the request for configuring parameters, by the configurer, the parameter of the calculation module to be configured.

A calculation module often consists of several parameters. The parameters may have an initial value that is known to work in the context of forming a prediction model, but these parameters may need to be customized for the different types of data. An advantage of having configurable parameters is thus to let the user to customize the calculation modules according to the data being used for verifying the prediction model. This may lead to a more accurate prediction model and consequently to more accurate predicted properties of data run through the prediction model.

According to yet another embodiment of the present invention, the method comprises providing a user interface for changing an order among a plurality of calculation modules previously added to the prediction model, the method further comprising the steps of:
a) receiving, from the user interface for changing a order, a request for changing the order among the plurality of calculation modules previously added to the prediction model,
b) reordering, as a result of the request for reordering, by the former, the plurality of calculation modules previously added to the prediction model.

When forming the prediction model, the user may want to change the order of the calculation modules added to the model. If, for example, a prediction model, which consists of a centring and scaling module followed by a PCA module, does not predict the known properties of the data in a satisfactory way, the user may want to try to reorder the modules. Additionally or alternatively the user may want to add one or more additional modules, such as a module for scatter correction say, dependent on, for example the results of a validation of the model or may want to remove certain modules if, for example, validation of the model indicates that desired variations to be modelled are being removed, say be over correction. By providing the user with the possibility to reorder, add or subtract the calculation modules instead of deleting the entire prediction model and start over, the user may both save time and experience forming the a prediction model in an intuitive way.

According to a further embodiment of the present invention, the method comprises providing a user interface for removing a calculation module previously added to the prediction model, the method further comprising the steps of:
a) receiving, from the user interface for removing, a request for removing an unwanted calculation module added to the prediction model,
b) removing, as a result of the request for removing, by the former, the unwanted calculation module from the prediction model.

The prediction model may be formed by numerous calculation models. By providing the user with the possibility to remove a calculation module instead of deleting the entire prediction model and start over, the user may both save time and feel that the forming of a prediction model is done in an intuitive way.

According to a further embodiment of the present invention, the method comprises providing a user interface for adding a recommended combination of calculation modules to the prediction model, the method further comprising the steps of:
a) receiving, from the user interface for adding a recommended combination, a request for adding a recommended combination of calculation modules to the prediction model,
b) adding, as a result of the request for adding a recommended combination, by the former, the recommended combination of calculation modules to the prediction model.

The user may want to start the process of forming a prediction model by starting from a recommended combination of calculation modules. From this starting point, the user may want to continue working with the prediction module by the way described above. An effect of this is that the user does not start from scratch when forming the prediction module, instead the user starts from a set of calculation modules that usually work well when building such a module. An advantage of this is that the user may save time. The recommended combination of modules may be incorporated in software implementing the method of the present invention. It may also be added to such software by the user itself, by a colleague or by someone else.

According to yet another embodiment of the present invention, the method further comprises providing a user interface for saving the prediction model to the computer readable storage medium, providing a processing unit for saving, by a saver, a prediction model to the computer readable storage medium, the method further comprising the steps of:
a) receiving, from the user interface for saving, a request for saving a prediction model to the computer readable storage medium,
b) saving, as a result of the request for saving, by the saver, the prediction model to the computer readable storage medium.

This makes it possible to allow the user to continue the work of forming the prediction model at a later time. The user may also want to save a successfully formed prediction model for use as a starting point the next time a prediction model is formed.

According to a further embodiment of the present invention the method comprises providing a user interface for adding a previously saved prediction model from the computer readable medium to the prediction model and providing a processing unit for loading, by a loader, a previously saved prediction model from the computer readable medium, the method further comprising the steps of:
a) receiving, from the user interface for adding a previously saved prediction model, a request for adding a previously saved prediction model to the prediction model,
b) loading, as a result of the request for adding a previously saved prediction model, by the loader, the previously saved prediction model from the computer readable medium,
c) adding, by the former, the loaded prediction model to the prediction model.

The effect of this is that if the user has a prediction model that has been previously saved, it is now made possible to load the prediction model and continue to work on it. The user may also load a previously saved prediction module and use it as a starting point when forming a new prediction model.

According to a second aspect of the present invention the above objects are achieved by a computer program product comprising computer program code portions adapted to perform at least parts of the method according to the first aspect of the invention when loaded and executed on a computer.

The second aspect may generally have the same features and advantages as the first aspect.

According to a third aspect of the present invention the above and further objects are also achieved by a graphical user interface for forming a prediction model for chemometric analysis,

the graphical user interface comprising:
a) a first graphical area configured to display a first set of graphical objects, each of the graphical objects representing a calculation module suitable for use in the prediction model;
b) a second graphical area configure to display a second set of graphical objects representing a set of the calculation modules added to a prediction model;
c) means for adding, as a result of an user input request, at least one of the calculation modules from the first area to the second area, thereby forming the prediction model;

each of the calculation module being arranged to receive data, having a required input data format, as input, perform a calculation and deliver data, having a output data format, as output,

each of the plurality of calculation modules having an output data format being compatible with the required input data format of each of the plurality of calculation modules thereby allowing the calculation modules to be added to the second graphical area, by the means for adding, in any number and/or in any order.

The third aspect may generally have the same features and advantages as the first and second aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, wherein:

FIG. 1 is a flowchart of a method according to an embodiment of the present invention,

FIG. 2 is a schematic view of a device implementing a method according to an embodiment of the present invention,

FIGS. 3-7 shows graphical user interface views according to embodiments of the present invention.

### DETAILED DESCRIPTION OF EMBODIMENTS OF THE INVENTION

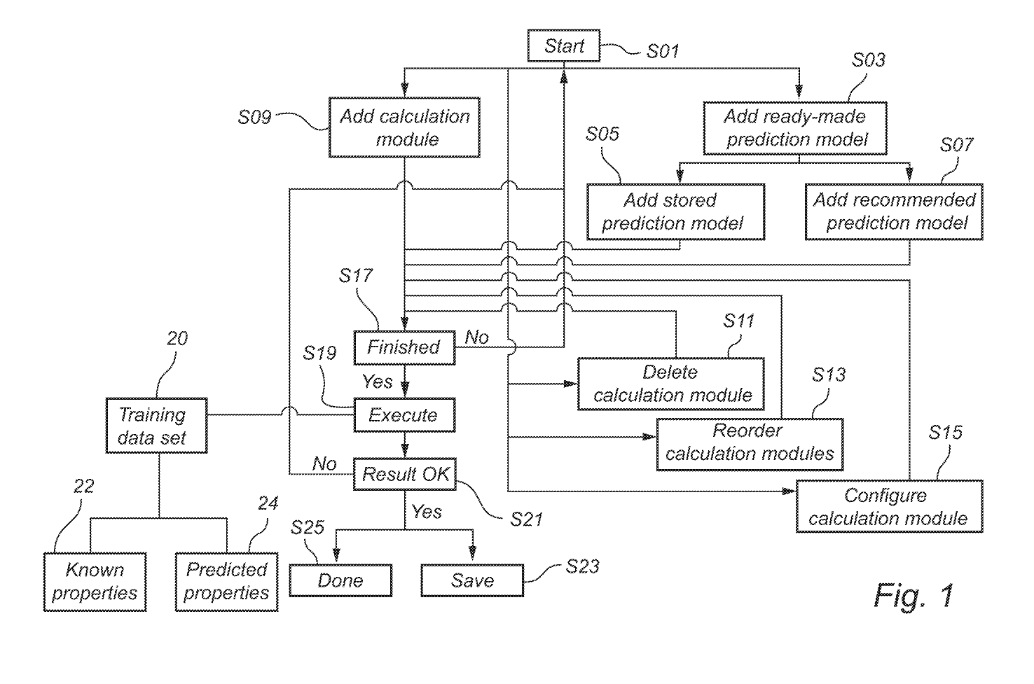

FIG. 1 is a flowchart of a method according to an embodiment of the present invention. The figure shows a workflow for forming a prediction model. The user starts (step S01) by either adding a ready-made prediction model (step S03) or by adding (step S09) one or several calculation modules to the prediction model to be formed. If the user wants to add a ready-made prediction model (step S03), the user can choose between adding a stored prediction model (step S05) from a computer readable storage medium or by adding a recommended prediction model (step S07). If the user then considers the work of forming a prediction model to be finished (step S17), the user can execute (step S19) the formed prediction model by operating the training data set 20 on the calculation modules added to the prediction model and then verifying (step S21) a quality of the prediction model by comparing the predicted properties 24 of the training data set 20 with the known properties 22 of the same data set 20.

If the result is satisfactory, the user may save (step S23) the model for later use before the user considers the work to be done (step S25). If, on the other hand, the user is not satisfied with the quality of the prediction model, the user may continue to form the prediction model by adding (step S09) additional calculation modules or deleting (step S11) a previously added calculation model or by change the order (step S13) of the previously added calculation models or by configuring (step S15) one or more parameters of a previously added calculation model. The above steps are iterated until a satisfactory result is accomplished.

By building the calculation modules in such a way that any of the calculation modules may follow or be followed by any of the calculation modules, the user is allowed to add (step S09, S05, S07) one/several calculation module(s) without restrictions. The user may also delete (step S11) and reorder (step S13) calculation modules previously added without any restrictions.

In a further embodiment of the present invention, the recommended prediction model (step S07) may also be stored on the computer readable storage medium and thus the step of adding a stored prediction model (step S05) and the step of adding a recommended prediction model (step S07) may migrate into one step.

The verification (step S21) of the prediction model may be an automatic step that presents a result to the user directly or it may be a manual step performed by the user or any other suitable person.

In a further embodiment of the present invention, the saving (step S23) of a prediction model may be performed at any time while forming the prediction model.

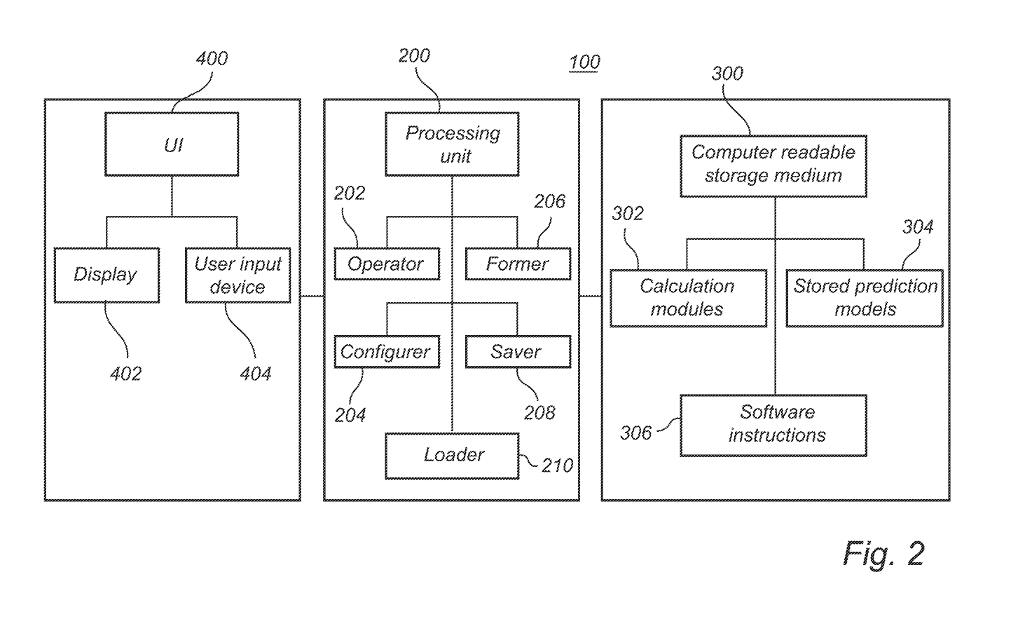

FIG. 2 is a schematic view of a device 100 implementing a method according to an embodiment of the present invention. The device 100 comprises a processing unit 200, which may be a central processing unit (CPU). The processing unit 200 is arranged to be operatively connected to an operator 202, a configurer 204, a former 206, a saver 208, a loader 210, a computer readable storage medium 300 and a user interface 400.

The memory 300 may be configured to store software instructions 306 pertaining to a computer-implemented method for forming a prediction model. The memory 300 may thus form a computer-readable medium which may have stored thereon software instructions 306. The software instructions 306 may cause the processing unit 200 to execute the method according to embodiments of the present invention.

The user interface 400 is arranged to receive user instructions and to present data processed by the processing unit 200. The user interface 400 may be operatively connected to the display 402 and a user input device 404. The user instructions may pertain to operations to be performed on the data items displayed by the display 402. The user instructions may origin from the user input device 404. An example of such user input device 404 is a mouse or a keyboard.

The computer readable storage medium 300 may be configured to store calculation modules 302 to be used by the operator 202, the configurer 204, the former 206 and the saver 208 to execute the method according to embodiments of the present invention.

The computer readable storage medium 300 may be configured to store stored prediction models 304 to be used by the loader 210 and the former 206 to execute the method according to embodiments of the present invention. The stored prediction models may be both user saved prediction models and recommended prediction models.

The computer readable storage medium 300 may store other attributes regarding the device 100 or the method of the present invention such as preferred UI settings, previous verification results etc.

The UI 400, the processing unit 200 and the computer readable storage medium 300 may be parts of the same device. They may also be parts of separate devices and connected by a network connection such as the Internet, a WIFI connection or a universal serial bus (USB) interface. The processing unit 200 could, for example, be placed on a separate server for improving the speed of the operator 202.

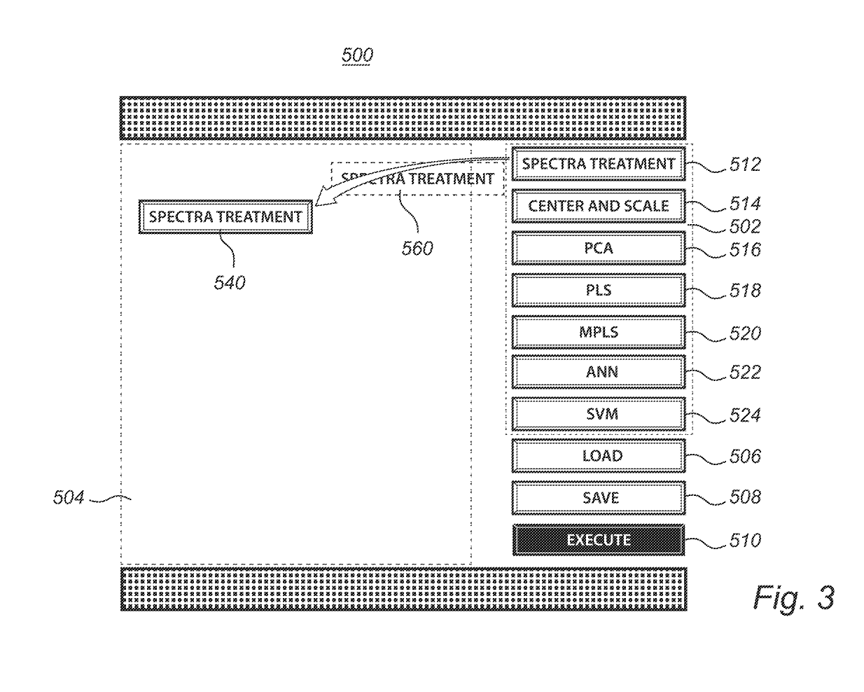

FIG. 3-7 shows an exemplary graphical user interface (GUI) 500 of software implementing the method of the present invention. A first graphical area 502 is configured to display a first set 512-524 of graphical objects; each of the graphical objects 512-524 is representing a calculation module suitable for use in the prediction model. A second graphical area 504 is configured to display a second set 542-544 of graphical objects representing the set of the calculation modules added to a prediction model. The calculation modules are added 560-564 to the second area by the user. The user may use a user input device as described in FIG. 2 for adding a graphical object from the first area to the second area. For example, the user may use the mouse and a drag-and-drop configuration.

FIG. 3 shows how the user adds 560 a spectra treatment calculation module 540 to the prediction model.

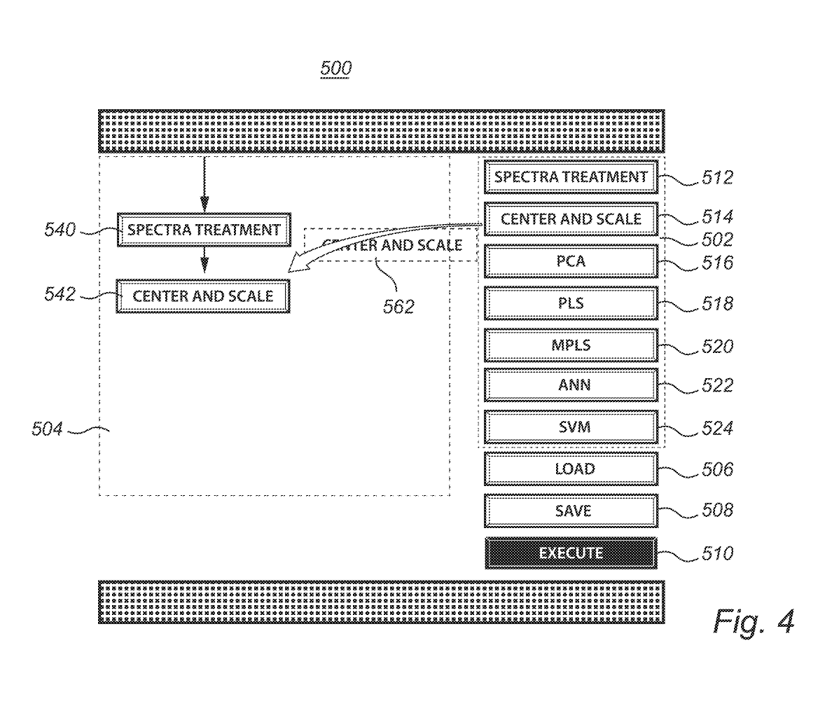

FIG. 4 shows how the user adds 562 a center and scale calculation module 542 to the prediction model.

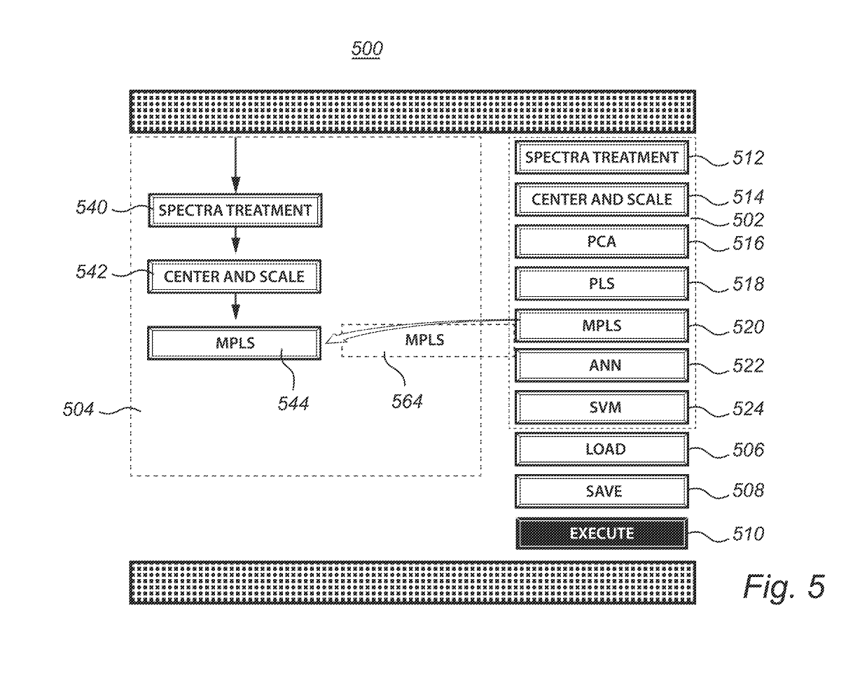

FIG. 5 shows how the user adds 564 a MPLS (modified part least square) calculation module 544 to the prediction model.

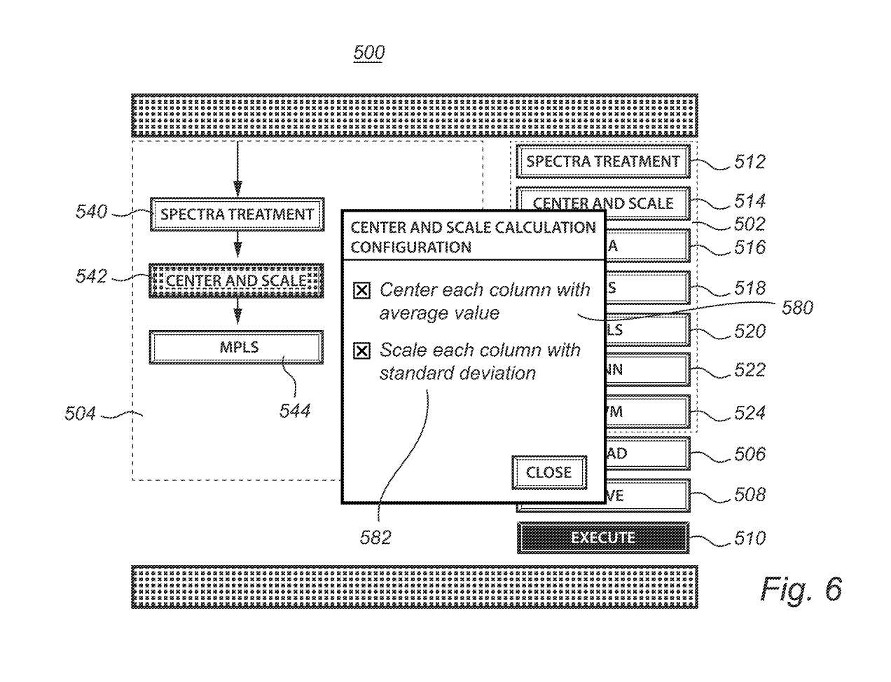

FIG. 6 shows a graphical user interface for configuring parameters of the center and scale calculation module 542. The user can select and configure appropriate parameters 580-582 for the selected calculation module 542. The user may open this view by using the mouse. Alternatively or additionally, a keyboard or any other suitable user input device could also be used.

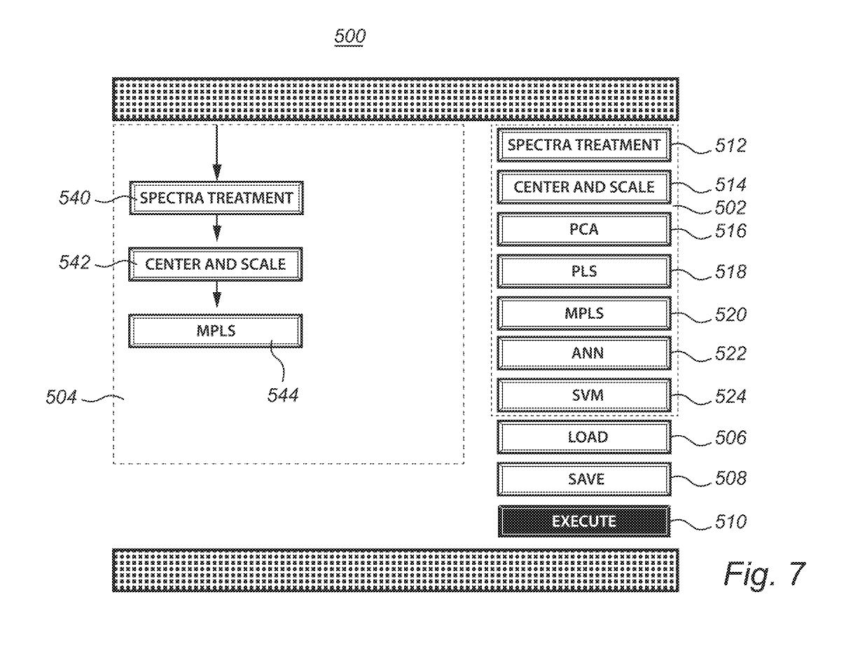

FIG. 7 shows how the user operating the prediction model by pressing the execute button 510. The user could also press the load button 506 for loading a previously stored prediction model or a recommended prediction model. The user could also press the save button 508 for storing the current prediction model to a computer readable storage medium. The use of a button is only to be seen as an example and is not limiting in any way.

According to one embodiment of the present invention, the user could change the relative order of the calculation modules 540-544 added to the prediction model by using the mouse and a drag-and-drop configuration. Alternatively or additionally, the arrow keys of a keyboard or any other suitable user input device could also be used.

According to one embodiment of the present invention, the user could delete one or several of the calculation modules 540-544 added to the prediction model with the delete key or the backspace key of a keyboard. Any other suitable user input device could also be used.

The person skilled in the art realizes that the present invention by no means is limited to the preferred embodiments described above. On the contrary, many modifications and variations are possible within the scope of the appended claims. For example, the adding 560-564 of calculation modules from the first area to the second area as shown in FIG. 3-5 could be done by the user pressing a specific key on a keyboard.

To summarize, herein is presented a method for forming a prediction model for chemometric analysis. A first graphical area 502 is configured to display a first set 512-524 of graphical objects; each of the graphical objects 512-524 is representing a calculation module suitable for use in the prediction model. A second graphical area 504 is configured to display a second set 542-544 of graphical objects representing the set of the calculation modules added to a prediction model. The calculation modules are added to the second area by the user. By building the calculation modules in such a way that any of the calculation modules may follow or be followed by any of the calculation modules, the user is allowed to add one/several calculation module(s) in any order and number, without restrictions.

1. A method for forming a prediction model for chemometric analysis, comprising:
providing a computer readable storage medium containing a plurality of calculation modules,
each of the plurality of calculation modules being a calculation module suitable for use in the prediction model,
each of the plurality of calculation modules being arranged to receive data, having a required input data format, as input, perform a calculation and deliver data, having an output data format, as output,
providing a processing unit for handling, by a former, the forming of the prediction model,
providing a processing unit for operating, by an operator, the calculation modules previously added to the prediction model,
providing a training data set with at least one known property for use when verifying the prediction model,
providing a user interface for operating the calculation modules previously added to the prediction model,
generating the plurality of calculation modules to be individually selectable,
providing a user interface for adding at least one of the plurality of selectable calculation modules to the prediction model,
the method further comprising the steps of:
receiving, from the user interface for adding modules, a request for adding at least one of the plurality of calculation modules to the prediction model;
adding, as a result of the request for adding, by the former, at least one calculation module to the prediction model, each of the plurality of calculation modules being constructed to have an output data format compatible with the required input data format of each of the plurality of calculation modules thereby allowing the step of adding at least one calculation module to the prediction model to be performed any number of times and permitting the calculation modules to operate in any order;
receiving, from the user interface for operating the calculation modules, a request for operating the calculation modules previously added to the prediction model;
operating, by an operator, in response to the request for operating, the the calculation modules previously added to the prediction model on the training data set thereby receiving at least one predicted property from the training data set; and
verifying a quality of the prediction model by comparing the at least one predicted property with the at least one known property.

2. A method according to claim 1, wherein at least two of the plurality of calculation modules has been added to the prediction model and the operator is operating at least two of the calculation modules added to the prediction model in parallel.

3. A method according to claim 1, further comprising providing a user interface for configuring parameters of each of the calculation modules, providing a processing unit for configuring, by a configurer, parameters of a calculation module,
the method further comprising the steps of:
receiving, from the user interface for configuring parameters, a request for configuring a parameter of a calculation module,
configuring, as a result of the request for configuring parameters, by the configurer, the parameter of the calculation module to be configured.

4. A method according to claim 1, further comprising providing a user interface for varying the number and/or order of calculation modules added to the prediction model, the method further comprising the steps of:
receiving, from the user interface for varying, a request for varying the number and/or order of calculation modules added to the prediction model,
varying, as a result of the request for varying, by the former, the calculation modules forming the prediction model.

5. A computer program product comprising computer program code portions adapted to perform at least parts of the method according claim 1 when loaded and executed on a computer.

6. A graphical user interface for forming a prediction model for chemometric analysis,
the graphical user interface comprising:
a first graphical area configured to display a first set of graphical objects, each of the graphical objects representing a calculation module suitable for use in the prediction model;
a second graphical area configure to display a second set of graphical objects representing a set of the calculation modules added to a prediction model;
means for adding, as a result of an user input request, at least one of the calculation modules from the first area to the second area, thereby forming the prediction model;
each of the calculation modules being arranged to receive data, having a required input data format, as input, perform a calculation and deliver data, having a output data format, as output,
each of the plurality of calculation modules having an output data format being compatible with the required input data format of each of the plurality of calculation modules thereby allowing the calculation modules to be added to the second graphical area, by the means for adding, in any number and/or in any order.

7. A graphical user interface according to claim 6 further comprising a graphical user interface for operating the calculation modules added to the prediction model.

8. A graphical user interface according to claim 6 further comprising:
a graphical user interface for configuring parameters of at least one of the calculation modules,

9. A graphical user interface according to claim 6 further comprising:
a user interface for varying one or both an order or a number of calculation modules of the second set of graphical objects representing the set of the calculation modules added to the prediction model.

10. A graphical user interface according to claim 6 further comprising:
a graphical user interface for saving the prediction model to the computer readable storage medium.

11. A graphical user interface according claim 6 further comprising:
a graphical user interface for adding a previously saved prediction model from a computer readable medium, the saved prediction model being formed by a set of calculation modules and represented by a set of graphical objects, to the second set of graphical objects representing the set of the calculation modules added to the prediction model.

12. A graphical user interface according to claim 6 wherein the means for adding at least one of the calculation modules from the first area to the second area comprises a drag-and-drop configuration for adding the at least one graphical objects representing the at least one calculation module from the first area to the second area.
